(19) United States
(12) Patent Application Publication
(10) Pub. No.: US 2025/0227097 A1
(43) Pub. Date: Jul. 10, 2025

(54) EFFICIENT AND SECURE DELIVERY OF REPETITIVE MATERIAL OVER A NETWORK

(71) Applicant: Robert Gezelter, Flushing, NY (US)

(72) Inventor: Robert Gezelter, Flushing, NY (US)

(21) Appl. No.: 19/017,369

(22) Filed: Jan. 10, 2025

Related U.S. Application Data
(60) Provisional application No. 63/619,388, filed on Jan. 10, 2024.

(51) Int. Cl. H04L 9/40; H04L 47/12; H04L 67/02

(52) U.S. Cl. CPC H04L 63/0478; H04L 47/12; H04L 67/02

(57) ABSTRACT

A system and method to reduce server-transmitted data volume in response to multiple independent client requests for identical data received from multiple client processes operating on one or more computing systems over a communications network. This approach enables intermediate network secure caching thus reducing transmission volume and server processing requirements through the elimination of duplicative data transmissions while preventing covert data modification by intermediaries.

### BACKGROUND OF THE INVENTION

The Internet has enabled near-instantaneous access to information on a global scale. The ubiquitous world wide web (WWW) is one example of such access. Client software programs for accessing the WWW are correspondingly referred to as “Web browsers.” Web browsers are available on computing devices of all sizes, from handheld devices to large-scale computers. The processes that provide web browsers with content are referred to as “web servers.”

First generation protocols used between web servers and their clients, e.g., HTTP [RFC 2068], use TCP connections and did not include provisions for either privacy (via encryption) or anti-tampering (data integrity). Private information, e.g., health and financial records, private correspondence, was thus exposed to monitoring and alteration by third-parties while transiting the network. HTTP includes provisions for caching of responses along the network route from web server to client.

Inserting an encryption/integrity layer between the HTTP applications layer and the underlying TCP transport layer addressed security and integrity. Netscape developed the original Secure Sockets Layer (SSLv3) [RFC 6101], since superseded by Transport Level Security (TLS) [RFC 2246]. SSLv3 and TLS interpose an encrypted communications channel on the TCP connection between a network-connected client and the network-accessible server. TLS has since been enhanced/revised several times. The present version is TLS 1.3 [RFC 8446], released in August 2018.

More recently, QUIC [RFC 9000] was developed to address perceived performance deficiencies when HTTP/TLS operates over TCP. QUIC is layered over datagram based UDP, although QUIC could theoretically have been implemented as an alternative transport protocol. Such a choice however, would have required modifications to firewalls and related devices throughout the Internet. Introducing a new transport-level protocol is far more complex and operationally challenging than using UDP.

HTTP/TLS and QUIC both implement an end-to-end encrypted communications channel that renders the data stream undecipherable and immune to tampering by intermediate network nodes. Such a channels shall be referred to herein as “opaque encrypted channels” or “opaque channels.” Encrypted channels inextricably intertwine privacy and anti tampering. However, privacy is not necessary for integrity and authenticity assurance, e.g., significant data volumes are widely-distributed and merely require assurance of integrity and authenticity. Examples of large frequently used data that require integrity and authenticity assurance but not privacy are non-private images, supporting web frameworks and libraries.

Web servers receive requests from client processes communicating over a network. Web server responses consist of response metadata, generally contained in “response headers” together with the bulk of the response, referred to as the “response body.” Response bodies include but are not limited to server-generated data, database extracts, images, web frameworks. For processing purposes, a response body can be considered as an ordered sequence of bytes. Response bodies for images and supporting web frameworks can significantly exceed 100,000 bytes. File contents are also ordered sequences of data bytes. Individual files are referenced by Uniform Resource Identifiers (URIs). A URI identifies an information source by access scheme, and unique name [RFC 3986]. For files, the unique name can be broken down into a hostname followed by a file path, optionally followed by a “?” and a series of parameters. The most common schemes used for accessing web servers are “HTTP” (unsecure) and “HTTPS” (secure). HTTPS connections use either a nested combination of HTTP and TLS over a TCP transport-level connection or QUIC (that includes the TLS functionality) over a UDP transport-level interface.

Request and data volume ebbs and flows over time, often due to external events, e.g., news, media events, commercial promotions, and other factors. Events may be predictable far in advance, e.g., elections, sporting events; or may arise with no advance notice from social media stories or other unanticipated real-world events. Bandwidth availability may be impaired by a variety of factors including demand surges, intra-network cross traffic volumes, and physical network infrastructure damage. Availability crises can occur on different scales, from the local area network, to continental or broader regions. [Gezelter CSH6] Customer-driven unanticipated surges in request volume are often referred to as “virtual mobs.”

Some retrieved data is sensitive, requiring encryption to ensure both privacy and integrity. Examples include Personally Identifiable Information (PII); personal health information protected by law, e.g., HIPAA; and personal financial information. Other information, while not confidential, must be protected from tampering. The present prior art protocols, e.g., HTTP/TLS and QUIC, use opaque encrypted connections between clients and servers to ensure both privacy and integrity. An end-to-end communications link is said to be opaque when only the end points can discern the contents of the communications.

A cache is a local storage copy of data stored primarily in a different location. CPU caches are critical to reducing effective memory access time. Caches for storage devices similarly reduce access time for frequently requested data. Various programs, e.g., web browsers, gateways, maintain caches of html and other files to locally resolve requests that would otherwise retrieving material from remote web servers.

In this description, “caches,” unless otherwise qualified, are contained within gateways, proxies, and other intermediate network nodes between the client and the server. These caches store copies of retrieved objects.

Caches often have criteria to control whether a particular item may be stored in the cache. Caches for HTTP-retrieved files may use header record information to determine cachability. The HTTP specification defines a particular header record to disable caching of an HTTP response body.

Opaque connections ensure privacy and authenticity. Network nodes between the web server and the client cannot covertly monitor or alter information in transit. However, significant data volumes, e.g., images, common JavaScript frameworks, are not individually sensitive, but do require integrity and authenticity assurances. Opaque connections preclude caching and other in network processing at intermediate points in the network.

Data networks are structured as layers, with each layer having different responsibilities, FIGS. 1 and 2. Bandwidth availability and connectivity are concerns of the Internet and Network layers. The Internet protocol on the global Internet is the appropriately-christened Internet Protocol (IP) [v4 RFC 791; v6 RFC2460].

User programs, including the processes running as web servers and browsers, do not typically use the Internet layer protocol directly. Rather, user programs generally use protocols at the Transport layer (or higher levels, that in turn use the Transport layer) to communicate with correspondents. The Internet protocols generally used for Transport are the Transmission Control Protocol (TCP) [RFC 793] and the User Datagram Protocol (UDP) [RFC 768]. QUIC [RFC 9000] implements a specialized HTTP Transport-level protocol to address shortcomings in TCP. QUIC in turn utilizes UDP as a transport protocol.

TCP provides a bi-directional, sequenced, error-free byte stream. Bytes sent are received by the partner process in the sequence sent. The TCP implementation is responsible for dealing with lost packets, retransmission requests, and other management of the Internet layer implementation.

UDP provides a minimalist wrapper on the underlying Internet layer. In contrast to TCP, when using UDP the application has total responsibility for managing errors relating to the underlying Transport layer. There are no guarantees of delivery or sequencing, the applications process has both complete freedom and responsibility.

A computing device consists of a unit containing a Central Processing Unit (CPU), memory, and a communications device connecting to a network. Such a device may contain secondary storage, e.g., solid-state disk (SSD); rotating disk (HDD); or other mass storage device. While secondary storage is common, it is not necessary for device operation. Desktop computers, laptop computers, tablets, mobile telephones, and other devices are examples of computing devices.

A network (104) is a collection of one or more nodes interconnected by communications links. In most networking schemes, degenerate networks within a single node are permitted.

For our purposes, any device with the network access capability is equivalent to a “computer” (120, 122, 123, 124), whether physically connected to a network (104, 119) with a wire, a wireless connection, or some combination thereof.

An executing program, referred to as a “process,” has a computational state including both the program code, read/write temporary storage, current instruction, and other execution-related context.

Processes that originate requests for information are referred to as “clients.” Web browsers are one type of client.

Processes that receive one or more connection requests and then respond to request(s) transmitted over the resulting connection are referred as “servers.” A server that receives requests and responds via HTTP/HTTPS is referred to as a “web server.”

It is possible for a single process to be a client for one purpose and act as a server for a different purpose.

Local connections within a particular computing device are allowed and common, thus a client may connect to a server on the same computing device using the degenerate (intranodal) network local to the computing device.

Some organizations may choose to arrange for owned or rented equipment at advantageous physical locations, e.g., communications exchanges, or third-party data centers. Such arrangements are generally referred to as “Content Delivery Networks.” A Content Delivery Network server (103) acts as a primary server for designated content. As Content Delivery Network servers are located topologically closer to requesting clients, they reduce response latency and network backbone traffic.

A packet-switched data network, generally referred to as a “data network” or simply “network,” is an assemblage of switching nodes, referred to as “switches” or “routers” and interconnecting communications links. Communications links may be wired, e.g., direct data connections, e.g., T1 telephone circuits, or local area networks, e.g., IEEE 802.3 series, or wireless, e.g., IEEE 802.11 series.

Some network nodes may have additional functions related to network security and management, these include firewalls, proxies, and gateways. The network itself may also encompass wired and wireless links as well as public IP networks, e.g., public broadband providers, both cable and fiber.

Requests for data can originate from a variety of clients including user-initiated web browsers, e.g., Google Chrome, Apple Safari, Mozilla Firefox, and Microsoft Edge, as well as free-running applications, e.g., Windows Update. A logical connection is requested from a client (120) to a server (100) through the network (104). The data transmitted in both directions may traverse a multiplicity of intermediate network nodes (104), or the network may be virtual and exist within a single computing device. Some network nodes will merely route data from one connection to another; network nodes referred to as “firewalls” may inspect the data to detect unauthorized and/or improper use (111); and yet other network nodes may inspect and/or alter addresses and other routing information for various purposes (111) [CSH3, CSH4, CSH5, CSH6]. Proxies and firewalls may or may not be combined in the same computing system.

Once a connection has been established between the client and the server, the client transmits a request to the server, FIG. 8. The server then responds to the request, FIG. 9. Server responses fall into three general categories:
Request successful. Response includes requested data
Request unsuccessful. Requested material not found or other server error
Request redirection. Response includes a redirect URI for retrieval of actual data

The first two categories (Request successful-data returned and Request unsuccessful) are complete. The third category (Request successful-URI for retrieval of data) requires an additional request (or requests as there is no limitation that the redirect URI does not itself return a redirect in turn to a different source).

The sequence of requests ends when a request is successful with returned data or a request terminates with a server error.

The prior art requires that each client requesting non-private data from a server receive a unique copy transmitted through the entire path between the server and each such client, utilizing server and network resources for each duplicative request. Repetitive transmissions increase capacity problems when large client populations attempt to access identical material at approximately the same time. In aggregate such requests frequently produce petabyte-scale network traffic surges. The resulting traffic surge is effectively a denial-of-service incident.

### SUMMARY OF THE INVENTION

The invention separates privacy from integrity/authentication, enabling secure response body caching at intermediate network nodes. This caching significantly reduces network data volume and web server processing requirements.

The invention separates the metadata required to access the requested information contents from the actual content. This separation allows the content to be transmitted over an unencrypted connection while ensuring authenticity and integrity. Since the caching related metadata is not encrypted but the content remains encrypted, intermediate network nodes can cache the data for future use without exposing the content from alteration or compromise.

Provided is a method for reducing server-transmitted data volume in response to multiple independent client requests for identical data received from multiple client processes operating on one or more computing systems over a communications network. In accordance with this new method, a client process, executing on a computing device, creates/requests a secure opaque communications link through a computer network to a server process. A first request for a specified object is transmitted, from the client process to the server process through the secure opaque communications link through the computer network. The server process transmits, through the computer network to the client process via the secure opaque communications link, a first response, the first response including a unique identifier for the specified object and a corresponding encryption method, a digest method, an object size, an encryption key, and a message digest. The client process transmits a second request, using the server-provided unique identifier, to the designated server process via an unencrypted communications link through the computer network. The server responds with the encrypted object via the unencrypted communications link through the computer network, and the client validates the received object using the length, message digest algorithm, and message digest value received in the first response. If the object is validated, then the contents are decrypted using the encryption algorithm and encryption key contained in the first response.

### BRIEF DESCRIPTION OF THE DRAWING

FIG. 1 illustrates a prior art Open Systems Interconnect Model.

FIG. 2 illustrates a prior art IETF Internet Model.

FIG. 3 is a block diagram of a prior art computer network.

FIG. 4 illustrates a prior art information flow.

FIG. 5 is a block diagram of a preferred embodiment of the present invention computer network.

FIG. 6 illustrates the information flow in the preferred embodiment of the present invention computer network.

FIG. 7 illustrates the intermediate cache content over time in the preferred embodiment of the present invention.

FIG. 8 illustrates a prior art Client Request to Server.

FIG. 9 illustrates a prior art Server Response to Client.

FIG. 10 illustrates a Client Request to Server in the preferred embodiment of the present invention.

FIG. 11 illustrates a Server Metadata Response to Client in the preferred embodiment of the present invention.

FIG. 12 illustrates a Server Multiple Metadata Response to Client in the preferred embodiment of the present invention.

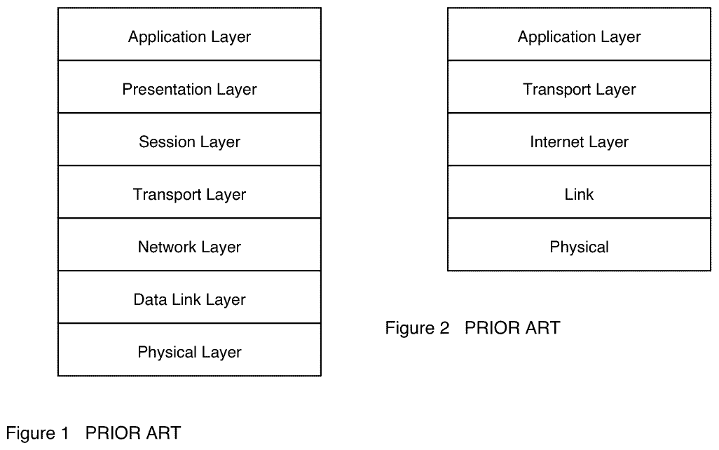

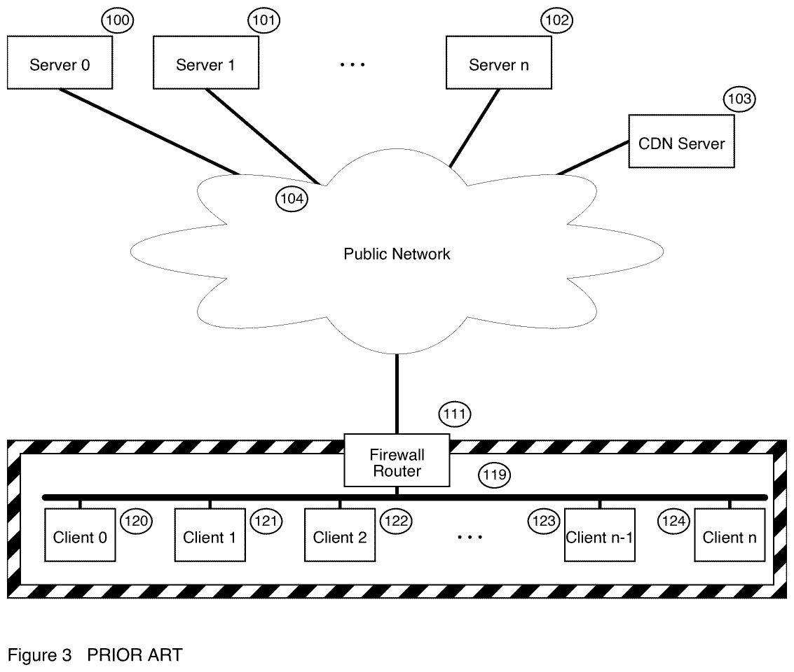

### DETAILED DESCRIPTION OF THE INVENTION

The prior art information delivery process presumes the use of an opaque encrypted channel between the information requestor (the “client”), and the information provider (the “server”). The detailed description will use the preferred embodiment of WWW requests/responses between a web browser client and a web server for illustrative purposes, although the precise same construction could be used for applications other than the WWW using protocols other than HTTP, HTTP/TLS and QUIC.

The prior art process needlessly intertwines privacy/confidentiality and integrity/authenticity. The opaque encrypted channels provided by both TLS and QUIC force unique encryption and transmission of each data request including those for non-confidential data. Confidential data represents a small portion of the data retrieved using HTTPS URIs. The unique encryption precludes measures to reduce this repetitive processing and transmission. This limitation is unnecessary.

Intertwining privacy/confidentiality and integrity/authenticity requires that each client requesting a URI-identified object receive a unique, uncacheable copy of that object from the web server.

This invention alters the paradigm.

The invention decouples privacy/confidentiality from integrity/authenticity. The resulting separation allows the URI-identified object containing non-private data to be securely cached at one or more intermediate nodes in the network. Securely cached means integrity and authenticity are preserved. The securely cached objects cannot be unpacked without the server-generated metadata necessary to unpack the object, e.g., encryption/digest/compression algorithms, encryption key(s), and message digest(s). Since the decryption and validation metadata can only be obtained from the originating web server, that server is free to impose limits on access, hence authorization.

The metadata returned via an opaque encrypted channel contains the information required to retrieve, validate, and unpack encrypted objects. The server may respond with the metadata for a single object, or it may return the metadata for an ordered list of multiple objects. If the response returns multiple objects, the contents of the specified objects are concatenated in the specified order for processing by the client.

Network nodes hosting intermediate secure caches do not have access to metadata necessary to unpack the cached object. JavaScript frameworks, images, news articles, and commonly used data collections are among the non-private data items that benefit from this invention. Since caching is opaque, third-party owned/operated nodes operating caches, e.g., those within a public or institutional provider, cannot covertly compromise the cached data.

Content Delivery Networks (CDNs) could utilize this invention to further increase delivery performance. While CDN nodes are topologically closer to end clients, on premise firewalls and proxies are even closer. This is particularly true for congregate settings, e.g., educational facilities, multi unit dwellings, and public venues.

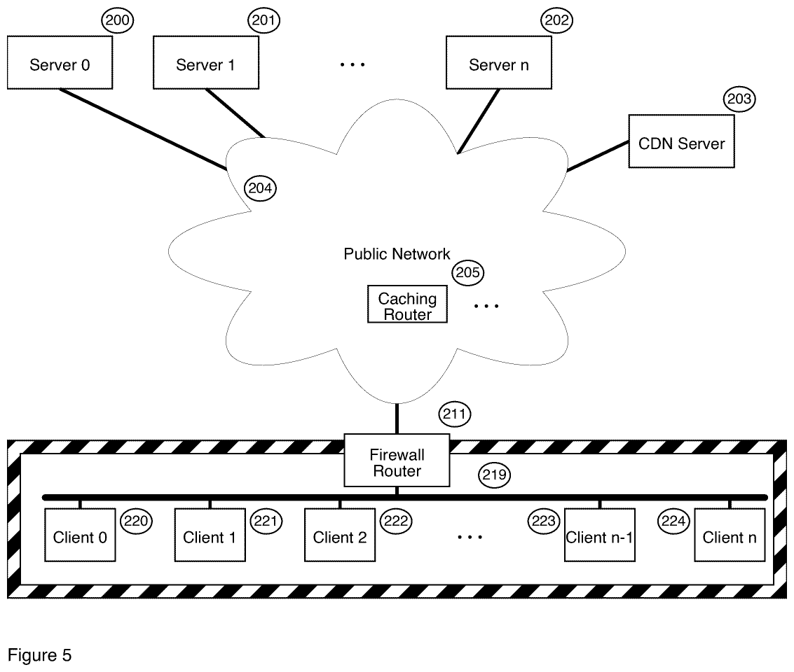

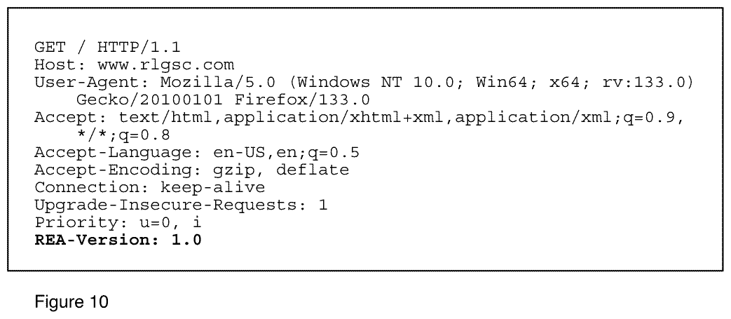

The invention bifurcates the client/server dialogue into two separate requests. With reference to FIG. 5, the client's (220) first request to the server (200) is almost identical to the prior art secure HTTP request over a HTTP/TLS or QUIC communications link: the URI of the requested object together with the possible addition of additional header records, see FIG. 10. The additional header records indicate to the web server whether the client has built-in support for the invention and, if so, the supported compression, message digest, and encryption algorithms.

The server then determines whether to respond with the contents of the URI identified file or to employ the subject invention. The server may examine configurable thresholds: activity rate; file size; pathname; workload; or other factors to arrive at a decision. The server may also include whether the client has built-in support for the invention in its decision.

If using the subject invention for this response, the web server will first determine if it has an unexpired, pre-processed copy of the appropriate object(s) (compatible with the requestor's compression, encryption, and digest algorithms) in its cache. If so, it can provide the object URI(s) and associated metadata for the requested object without further processing. It is possible that some pre-processed objects will be available in the web server cache and others requested objects may require processing before they are available for transmission.

If an appropriate pre-processed object is not available, the web server will access the contents of the URI identified file to generate the required uniquely-named object(s). Each object may be compressed as part of the object creation process. The possibly compressed contents will then be encrypted using a random encryption key and processed by the selected message digest algorithm producing a message digest value. The object and its associated unique name, expiration time, encryption key, message digest, and chosen compression, encryption, and message digest functions will then be stored by the web server for later reference.

When the web server determines that all object(s) responsive to the client request are available, the web server will begin generation of its response to the client.

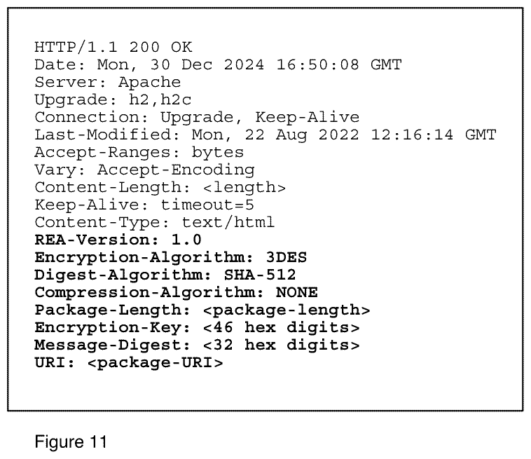

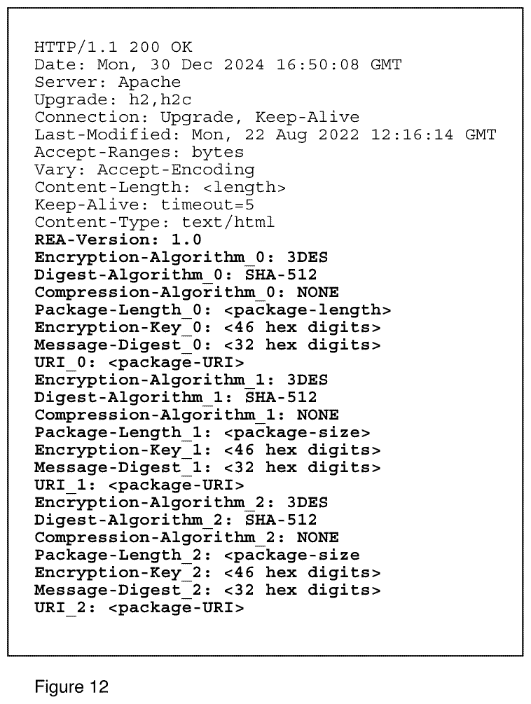

The response to the first request contains the one or more unique object URIs, together with each object's corresponding compression, encryption, and digest algorithms used, as well as the associated metadata: encryption key, message digest, payload length, and expiration time of year, see FIG. 11. The web server response may contain more than a single object URI, together with the metadata for each object, see FIG. 12. When unpacked the client sees the multi-URI list contents as a single sequence, as would have been received by the prior art approach.

The server then responds over the opaque connection with the unique object name(s) together with each object's associated unpacking metadata, e.g., compression/encryption/digest methods, digest, size, together with a header indicating that the response uses the subject invention, see FIG. 12. This metadata may be supplied in the body of the response, or it may be included in special header records. If the requesting client does not include built-in support for the subject invention, the server will provide the client with an executable object, e.g., JavaScript or WebAssembly implementation of the client-side aspect of the subject invention.

When the requesting client receives the first response, the requesting client will open an unencrypted HTTP connection to the web server-generated metadata-supplied URI requesting each of the web server-supplied URIs. The client may elect to do these requests serially, in parallel, or some combination, depending upon resources and other factors.

When the web server receives an HTTP request over the unencrypted channel, the requested object URI contents are returned. The HTTP headers are set to permit caching and the expiration time is populated with the expiration time from the object cache entry.

The object is encrypted, protecting the contents. However, the HTTP connection over which the response is transmitted is not encrypted. The object URI is visible to intermediate nodes, as are the cacheability and expiration time/date. The visible URI and cacheability information enable intermediate network nodes, e.g., firewalls (211), proxies, gateways, and routers (205) within the network (204) to cache an object copy for later use, see FIG. 5. This cached copy can be provided to the same or other clients when requested. This eliminates the need to separately encrypt and transmit repetitive material requested by multiple clients on multiple, independent computing devices.

Unencrypted caches are vulnerable to caching node misconduct and cache poisoning attacks [see RFC9111]. The invention's opaque caches hosted on intermediate network nodes are immune to such attacks. The opaque object cached by the intermediate node is encrypted by, and has a message digest produced by the server. Even if the caching node were to obtain the encryption key required to decrypt/unpack the opaque object, it is computationally infeasible alter the object contents while maintaining the server-computed message digest. Clients retrieve the encryption/digest algorithms, encryption keys, and message digest values directly from the server via a secure, opaque network connection.

An example is illustrative.

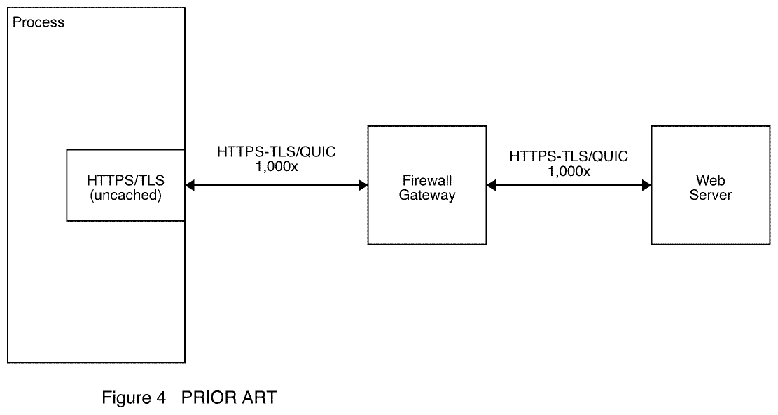

If a client (220) wants to retrieve JAVASCRIPT.JSP from server XYZ.COM and ensure that the object is not somehow intercepted and altered by an intermediary, the client opens a secure connection uses an HTTPS scheme and specifies the URI indicating the server and file, e.g., HTTPS://XYZ.COM/JAVASCRIPT.JSP. The server can respond with the object directly or it could return a redirect URI, e.g., HTTPS://CODESERVER.XYZ.COM/JAVASCRIPT.JSP. In either case, a complete copy of JAVASCRIPT.JSP (the “object”) is provided, free from the possibility of interception or tampering. If JAVASCRIPT.JSP is 1,000,000 bytes (1 MB) in length, that would require a unique copy be transmitted to each client requesting the file. If 1,000 different clients request the object, the aggregate transmission would be 1,000,000,000 bytes (1 GByte), see FIG. 4. The 1 GByte aggregate transmission would happen even if the 1,000 different clients are in a single congregate setting, e.g., a building connected to the public Internet by a single broadband connection protected by a single firewall. Examples of such an environment would be an educational institution, a public venue, or a large residential complex.

Both HTTP/TLS and QUIC generate a unique encryption key for each connection. 1,000 retrieval requests would necessitate 1,000 unique encryptions of the 1 MByte object. Servicing these requests requires processing power, network connections, and communications capacity to process 1 GByte of data. Resource requirements scale linearly with the number client requests.

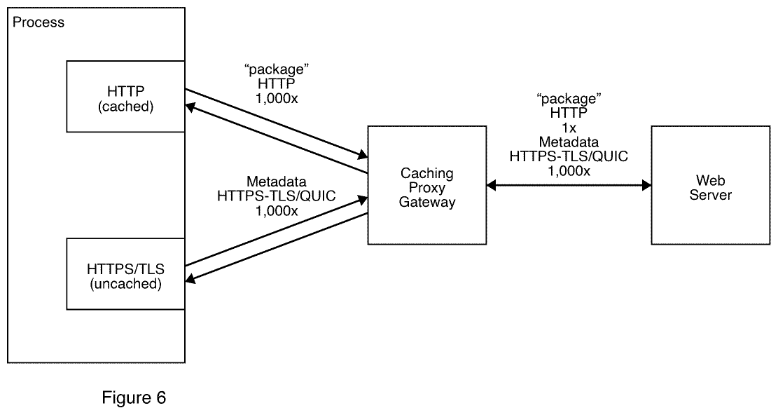

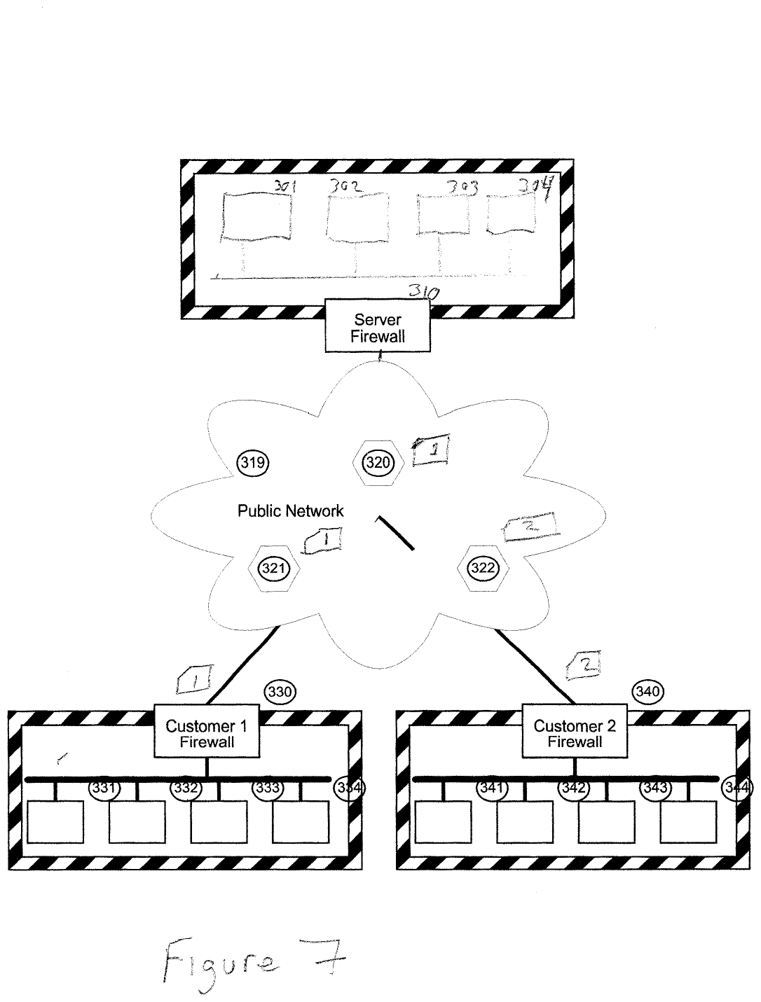

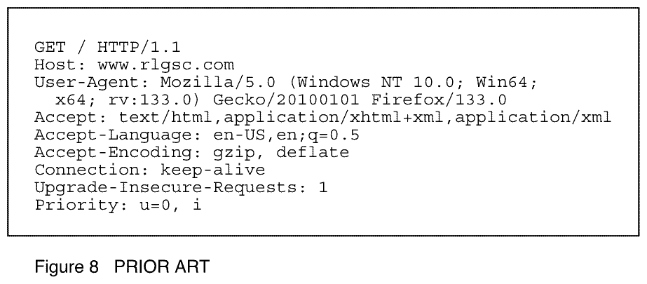

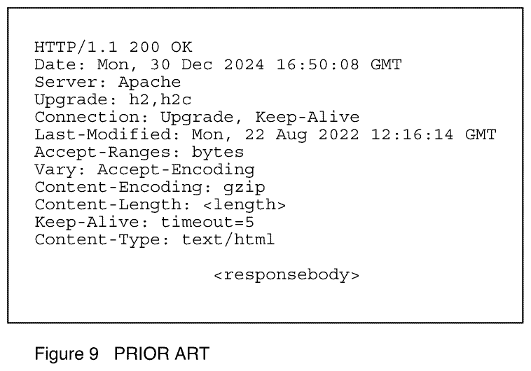

By contrast, the invention dramatically reduces resource requirements for the example request to a fraction of the prior art, with a logarithmic growth curve, see FIG. 6.

The invention starts with a client (220, 331) sending a request to a server (201, 301). For simplicity, the secure retrieval of file JAVASCRIPT.JSP from server XYZ.COM. As with the prior art solution, the URI HTTPS://XYZ.COM/JAVASCRIPT.JSP is requested from the server (201). The client request is transmitted to the server via the secure opaque channel via the network (204), transiting through the local firewall (211) and at least one network node, caching router (205).

As with the prior art case, the server (201, 301) responds with a redirect URI of HTTPS://CODESERVER.XYZ.COM/JAVASCRIPT.JSP. The client then securely requests the redirect URI. The prior art approach would return the 1 Mbyte object in response on the HTTPS or QUIC connection. The invention approach differs. The server may elect to process the request in the prior art fashion, returning the object in response to the request. Alternatively, the server may, depending upon the expectation of reuse, object size, object request frequency, and other factors, elect to generate a persistent encrypted copy of the requested object, assigning it a server-generated URI, e.g., HTTP://CODESERVER.XYZ.COM/CACHE/768298AF76B.REA (hereafter in this example, “BLOB”, a BLOB is defined as an “large sequence of unstructured bytes”, as in Binary Large OBject), together with associated metadata required to retrieve and unpack the BLOB including: encryption algorithm; digest algorithm; encryption key; message digest value; object size; and expiration date/time. The server will then respond to the client request by storing a server-generated BLOB containing the contents of HTTPS://CODESERVER.XYZ.COM/JAVASCRIPT.JSP together with the associated metadata as described. The server will then answer the first request with the server-generated BLOB URI and associated metadata via the secure connection. This assures both the privacy and integrity of the response.

When the client detects that the server response contains one or more BLOB URIs and associated metadata, the client then uses each of the BLOB URIs to retrieve the specified file using unencrypted HTTP most likely using essentially the same path as the secure opaque channel, except for the absence of encryption. As noted in the general description of the invention, the use of unencrypted HTTP is foundational.

The server will process the unencrypted HTTP request and respond with the pre-encrypted BLOB. As previously noted, the BLOB contents are pre-encrypted and secured by the server-computed message digest. The URI is unencrypted and can be used by firewalls (211, 310, 330, 340) and other network nodes (205, 320, 321, 322) to cache the BLOB for later use, see FIG. 7. Outdated BLOBs are purged when they reach their end-of-life or the intermediate node's discretion, e.g., usage frequency vs. available space. Other than performance, there is no adverse impact when an intermediate cache expunges a cached BLOB. Intermediate caches may be purged due to capacity constraints, lack of activity, node reboot, or other reasons.

When the client receives the requested BLOB, the client verifies the message digest value and length against the server-provided message digest value and length contained in the secure response from the server. If the values do not match, the BLOB has been altered enroute and is not valid. An invalid BLOB must be discarded. If the invalid BLOB is part of a multiple BLOB list, the entire retrieval must be aborted with a terminal error result. If the BLOB passes validation, the BLOB creation processing is reversed, with the BLOB being decrypted and decompressed as necessary. The resulting byte stream is processed by the client as if had been received in the conventional manner.

When a second client (221, 341) requests the same URI, e.g., HTTPS://CODESERVER.XYZ.COM/JAVASCRIPT.JSP the server follows the same execution path until it notes that the web server cache storage contains a pre-processed BLOB for HTTPS://CODESERVER.XYZ.COM/JAVASCRIPT.JSP together with the associated metadata. The server responds with the unique URI and associated metadata for the previously processed BLOB.

The second client (221, 341) will then use HTTP to retrieve the BLOB using the server supplied URI (FIG. 7). As the retrieval request navigates the intervening network enroute to the web server, one of the network nodes (320) may already have an unexpired cached copy of the BLOB. The cached BLOB will then be supplied to the client and other processing appropriate for a cached entry will be performed. The server will receive notification that the request was serviced by an intermediary. The notification permits the server to keep track of BLOB usage (The original metadata request is logged by the web server for URI accounting).

In turn, intermediate network nodes (340, 322) in the network path from the second client (341) to the existing intermediary cache node (320) are free to cache the BLOB in turn.

Using firewall and proxy caches to satisfy common requests reduces server and network workload. Local firewalls typically have high-capacity network links (Local Area Network speeds of 100 Mbits/second are common) to local clients; upstream network infrastructure is shared by large numbers of customers, reducing effective individual customer capacity.

Capacity constraints are particularly apropos when there is mass interest in a URI, for example a so-called “virtual mob.” This invention reduces network traffic, even when the lifespan of the cached BLOBs is measured in seconds, e.g., breaking news stories, stock graphs. Material with longer lifespans, e.g., JavaScript framework files, images, web site boilerplate material, and historical data yields even greater efficiencies. As each BLOB has metadata specifying lifetime, the web server can set lifetime to an appropriate value depending upon the type or class of data. Static data collections may have long lifetimes; information packages subject to change may have shorter lifetimes.

What is claimed is:

1. A method for reducing server-transmitted data volume in response to multiple independent client requests for identical data received from multiple client processes operating on one or more computing systems over a communications network, said method comprising:
a client process, executing on a computing device, creating a secure opaque communications link through a computer network to a server process;
transmitting, from the client process to the server process through the secure opaque communications link through the computer network, a first request for a specified object;
the server process transmitting, through the computer network to the client process via the secure opaque communications link, a first response, said first response comprising a unique identifier for the specified object and a corresponding encryption method, a digest method, an object size, an encryption key, and a message digest;
the client process transmitting a second request, using the server-provided unique identifier, to the designated server process via an unencrypted communications link through the computer network;
the server responding with the encrypted object via the unencrypted link;
the client validating the received object using the length, message digest algorithm, and message digest value received in the first response; and
if the object is validated, then decrypting the contents using the encryption algorithm and encryption key contained in the first response.

2. The method of claim 1 wherein the server also supplies an executable object to perform the retrieval and validation, decryption, and decompression steps.

3. The method of claim 1 wherein the server provides the metadata for an ordered collection consisting of multiple objects to the client.

4. The method of claim 1 wherein the unsecure protocol is HTTP, or an equivalent.

5. The method of claim 1 wherein the secure protocol is HTTP/TLS, QUIC, or equivalent.

6. The method of claim 3 where the objects have different expiration times.
